(19) United States
(12) Patent Application Publication
(10) Pub. No.: US 2026/0333103 A1
(43) Pub. Date: Oct. 22, 2026

(54) ONBOARDING TIME AND ROAMING PAUSE TIME MEASUREMENT REPORTING

(71) Applicant: Cisco Technology, Inc., San Jose, CA (US)

(72) Inventors: Brian D. Hart, Sunnyvale, CA (US); Jerome Henry, Pittsboro, NC (US); Arun G. Khanna, Sunnyvale, CA (US); Binita Gupta, San Diego, CA (US)

(21) Appl. No.: 19/634,203

(22) Filed: Mar. 31, 2026

Related U.S. Application Data
(60) Provisional application No. 63/790,374, filed on Apr. 17, 2025.

(51) Int. Cl. H04W 24/10

(52) U.S. Cl. CPC H04W 24/10

(57) ABSTRACT

In one embodiment, a method is performed by a non-access point station (STA) in a wireless network, the method comprising: recording, by the STA, a time measurement for occurrence of each of a plurality of ordered milestones associated with at least one of an onboarding process to an access point (AP) and a roaming process associated with the STA roaming from a serving AP to a target AP, wherein the plurality of ordered milestones comprise events spanning from a network discovery event to a network connectivity event; encoding information related to the time measurements for the plurality of ordered milestones into at least one field of a measurement report frame; and transmitting the measurement report frame to the AP or the target AP following completion of at least one of the onboarding process and the roaming process.

### CROSS-REFERENCE TO RELATED APPLICATION

This application claims priority to U.S. Provisional Patent Application No. 63/790,374, filed Apr. 17, 2025, entitled “Onboarding Time and Roaming Pause Time Measurement Reporting,” the entirety of which is incorporated herein by reference.

### TECHNICAL FIELD

The present disclosure relates to wireless networks.

### BACKGROUND

In IEEE 802.11 wireless networks, there are two metrics of wireless reliability:
1) how long it takes for a wireless client to onboard to the network, and
2) how long the data "pause" time is when the wireless client roams from one access point (AP) multi-link device (MLD) to another AP (MLD).

In order to market the value of improved roaming and motivate adoption of the latest generation of roaming technology, being able to characterize the benefits of the latest technology versus the previous technology is particularly useful. The information related to those benefits resides wholly or partly on the wireless client, making it difficult to extract and thus collect statistics on and report about it.

Knowing the roaming pause time can help clarify the benefits of non-fast transition (FT) roaming versus FT roaming versus seamless management domain (SMD) roaming, as well as the effect of APs being on the same versus different channels. However, no such metric(s) exist. That clarity can be used to reorient the priority for the development and enablement of enhanced roaming features, and also identify any areas where they might fall short.

Onboarding time is similar to roaming pause time, although instead of AP (MLD) to AP (MLD) like for roaming, onboarding is from no network or another network to a first AP (MLD). Again, it is a useful metric since an extended onboarding time yields a poor user experience (like a long roaming pause).

Heretofore, no such metric is defined. In other words, such a metric is not addressed by any type of IEEE 802.11k++ Measurement Request/Report).

### BRIEF DESCRIPTION OF THE DRAWINGS

FIG. 1 illustrates a block diagram of a wireless network that includes wireless clients and access points (APs) to which wireless clients may associate and between which wireless clients may roam, according to an example embodiment.

FIG. 2 illustrates a block diagram of a wireless network including access points and a non-access point station (non-AP STA) transmitting onboarding measurement reports, according to an example embodiment.

FIG. 3 illustrates a message-exchange diagram between a first device and a second device depicting transmission and acknowledgment events associated with frame exchanges that may serve as the basis of measurements reporting in the embodiments presented herein.

FIG. 4 illustrates a block diagram of a wireless network including APs and a non-AP STA transmitting roaming measurement reports, according to an example embodiment.

FIG. 5A illustrates a frame structure of an Ultra High Reliability (UHR) Link Reconfiguration Notify frame including a frame body field for carrying measurement-related information, according to an example embodiment.

FIG. 5B illustrates a frame body structure including an action field and optional vendor-specific elements that are part of the UHR Link Reconfiguration Notify frame shown in FIG. 5A, according to an example embodiment.

FIG. 5C illustrates parts of the action field depicted in FIG. 5B, according to an example embodiment.

FIG. 5D illustrates type field values of the action field shown in FIG. 5C that may be used to carry measurement reports, according to an example embodiment.

FIG. 6 illustrates a flow chart depicting a method performed by a non-AP STA to transmit a measurement report related to onboarding or roaming, according to an example embodiment.

FIG. 7 illustrates a flow chart depicting a method performed by an AP to transmit a measurement request to a non-AP STA to solicit a measurement report related to onboarding or roaming by the non-AP STA, according to an example embodiment.

FIG. 8 is a block diagram of a wireless device that may be configured to perform techniques presented herein, according to an example embodiment.

### DESCRIPTION OF EXAMPLE EMBODIMENTS

### Overview

Presented herein are techniques to quantify gains of improving roaming and any onboarding features by enabling wireless clients to report measurements or statistics related to onboarding and/or roaming. In one embodiment, a method is performed by a non-access point station (STA) in a wireless network, the method comprising: recording, by the STA, information related to the occurrence of each of a plurality of ordered milestones associated with at least one of an onboarding process to an access point (AP) and a roaming process associated with the STA roaming from a serving AP to a target AP, wherein the plurality of ordered milestones comprise events spanning from a network discovery event to a network connectivity event; computing information related to one or more components determined from the information related to the plurality of ordered milestones; encoding the information related to the one or more components into a measurement report frame; and transmitting the measurement report frame to the AP or the target AP at or following completion of at least one of the onboarding process and the roaming process.

In another embodiment, a method is provided that is performed by an access point (AP) in a wireless network, the method comprising: transmitting, by the AP, a measurement request frame to a non-access point station (STA), the measurement request frame requesting information related to the occurrence of all or a requested subset of a plurality of ordered milestones associated with at least one of an onboarding process to the AP or a roaming process for one or more durations between pairs of the plurality of ordered milestones; receiving, by the AP, a measurement report frame from the STA, the measurement report frame comprising information related to one or more components determined from the information related to the plurality of ordered milestones; and processing, by the AP, the measurement report frame to determine at least one performance parameter associated with the at least one of the onboarding process or the roaming process.

### Example Embodiments

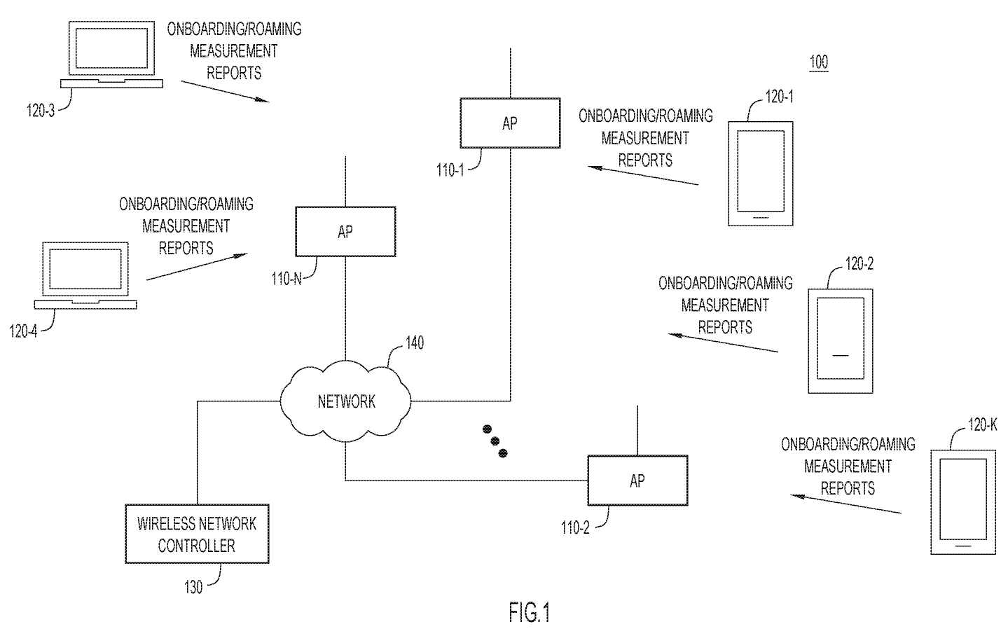

FIG. 1 illustrates a wireless network 100 that includes access points (APs) 110-1, 110-2, …, 110-N and non-APs (e.g., wireless clients (stations, STAs)) 120-1, 120-2, 120-3, 120-4, …, 120-K. The wireless network 100 may include a wireless network controller 130 that may control the operation of the wireless network 100. The APs 110-1 to 110-N may connect to a network 140, e.g., a wired network, which may be a local area network or a wide area network. One or more of the APs 110-1 to 110-N may be a Multi-Link Device (MLD), i.e., an AP MLD, and similarly, one or more of the STAs may be a MLD, STA MLD or Non-AP MLD.

Non-APs 120-1, …, 120-K, can onboard to the wireless network 100 by associating with one of the APs 110-1 to 110-N. Moreover, the non-APs 120-1 to 120-K may roam from one AP to another AP. As shown in FIG. 1, one or more of the non-APs 120-1 to 120-K are configured, according to the techniques presented herein, to provide onboarding-related measurement reports associated with milestones related to onboarding to the wireless network 100 through association with an AP. Moreover, one or more of the non-APs 120-1 to 120-K are configured or are otherwise capable of responding to a request to provide roaming-related measurement reports associated with milestones related to roaming between APs in the wireless network, according to techniques presented herein. In other embodiments, the onboarding-related measurement reports and/or roaming-related measurement reports may relate to milestones observed at the AP and sent by the AP to the non-AP STA.

### Reporting Onboarding Time

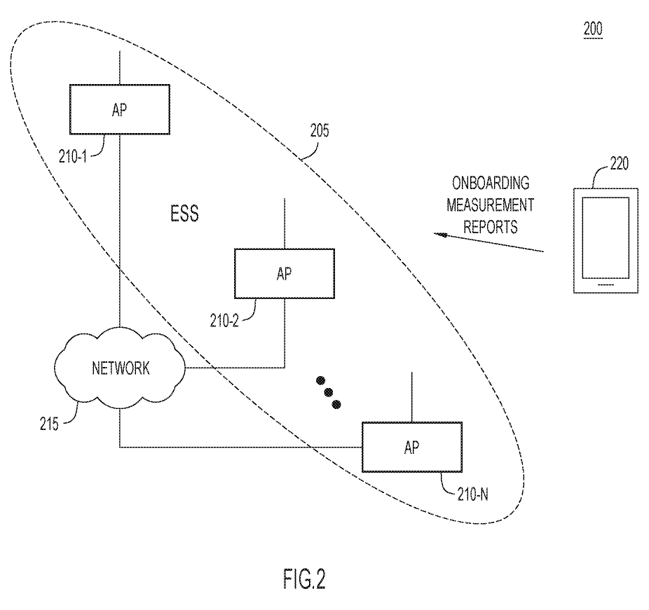

Reference is now made to FIG. 2. FIG. 2 illustrates a wireless network 200 that includes an Extended Service Set (ESS) 205 comprising APs 210-1, 210-2, …, 210-N. The APs 210-1 to 210-N are connected to a network 215, such as a local area network or a wide area network. A non-AP 220 (e.g., a wireless client or STA) is shown attempting to onboard to the ESS by associating with AP 210-2, for example. An ESS is a collection of interconnected Basic Service Sets (BSSs) that allow STAs to roam freely between APs (BSSs) while maintaining a single network connection. Each BSS in an ESS shares the same Service Set Identifier (SSID) and security settings. Also, one or more of the APs 210-1 to 210-N may be an AP MLD, and the non-AP 220 may be a non-AP MLD.

In accordance with one aspect, a non-AP, e.g., non-AP 220 (STA), is configured to report or otherwise is capable of responding to a request to report a set of parameters related to onboarding time to its associated AP, e.g., AP 210-2. In other embodiments, the onboarding time of a non-AP STA is determined at the AP and the AP reports it to the non-AP STA. This time can comprise multiple components (some of which the AP can determine autonomously and some of which it cannot). The STA (or AP, as the case may be) determines components from the plurality of ordered milestones. For example, a set of ordered milestones may comprise milestones A, B, C, and D, but components determined from the ordered milestones A, B, C, and D may not be ordered, such as a component related to a duration between milestone C and milestone A (C-A), and a component related to a duration between milestone D and milestone A (D-A), and a component related to a duration between milestone D and milestone B (D-B). The time for one component or a concatenation of components can be signaled in many different but equivalent (e.g., convertible) ways, including (a) a duration, (b) a start and end time, (c) a start time when the peer can determine the end time or the end time is included elsewhere in the same message (e.g., for a different component), and (d) an end time when the peer can determine the start time or the start time is included elsewhere in the same message (e.g., for a different component).

A component may be defined as the time between any two of the following milestones listed below. These milestones generally occur sequentially in the order that they are listed. Thus, as one example, one component to be reported is the time between milestone 1 (STA first wanting to discover an ESS (“speculative scanning”)) and milestone 2 (STA first discovered the associated AP’s ESS). However, again, another component may be the time between milestone 1 and milestone 3 (STA first wanted to join an ESS (e.g., after a user selects that SSID in a user interface)). Alternatively, it may be desirable to report on the time between the first milestone and the seventh milestone, and then the seventh milestone to the tenth milestone. These are just examples. In some instances, these milestones have sub-parts, referred to as micro milestones.

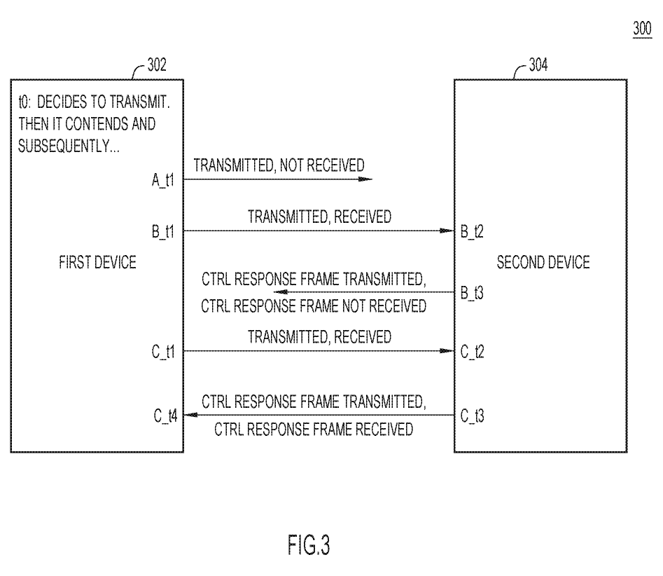

To this end, reference is made to FIG. 3. FIG. 3 shows micro milestones associated with a frame exchange sequence 300 between a first wireless device 302 and a second wireless device 304, where the wireless devices may be a STA (non-AP) or an AP.

Each (attempted) frame exchange sequence (request and control response, e.g., acknowledgment/block acknowledgment) may have up to 5 (micro) milestones and corresponding timestamps (but 3 non-trivially different values):
t0: Initiator wireless device decides to transmit, and enqueues a request (such as in the form of a Media Access Control (MAC) Service Data Unit (MSDU) or Management MAC Protocol Data Unit (MMPDU)) for transmission.
t1: Transmit time of the request.
t2: Receive time of the request, which is close enough to t1 that they can be treated as the same, ignoring (a) a mostly negligible time of flight, and (b) assuming the timebases are common or convertible, such as both wireless devices 302 and 304 being synchronized to AP time.
t3: Transmit time of a control response to the request.
t4: Receive time of a control response, which is close enough to t3 that they can be treated as the same.

FIG. 3 shows two kinds of non-successes, denoted by the prefixes A and B, and one kind of success, denoted by the prefix C. There may be multiple instances of A and/or B before the final, successful C exchange. There is a failure mode not shown in FIG. 3, where the medium is always busy and the first wireless device 302 never gets past contending for access to the medium.

If the second device 304 is an AP, the AP often wants to know the time between C_t4 and t0, but it does not have visibility to that. For example, the AP only knows the time between C_t3 and B_t2 and knows nothing about t0 or any A transmission attempt(s) that fail. Further, if the actual exchanges were A-A-A-A-C, where (A-A-A-A) are 4 preceding failed transmission attempts, then the AP only sees C_t2 and C_t3, and never knows anything related to the 4 preceding failed attempts.

Thus, a request + response exchange (each with control response frames) may be described by 3 - 4 main timestamps (milestones):
t0, start of the intent to transmit.
Tfirst, the time of the first attempt (e.g., A_t1 or B_t1 or C_t1), which is approximately the same as A_t2, B_t2, or C_t2).
Tlast, which is one of:
   Tlast(1): the time of the successful attempt (C_t4, which is approximately equal to C_t3); and
   Tlast(0): the time at which the wireless device gave up (e.g., at or after A_t1 or B_t1 or some timeout after t0)

With the context described above in connection with FIG. 3, the onboarding milestones may include the following, in sequential order as enumerated below.
1. STA first wants to discover an ESS (e.g., speculative scanning). The STA is always scanning to detect a network to which to connect.
2. STA first discovers the associated AP's ESS, but perhaps the STA is still scanning.
3. STA first wants to join an ESS. For example, the user selects an SSID in a user interface or an auto-join process on the STA selects a particular AP at this particular time.
4. STA picks out (selects) an AP (or AP MLD) from the ESS with which to connect and determines to connect to that AP. For example, the non-AP 220 in FIG. 2 selects AP 210-2 from the ESS 205. This milestone is not visible to the AP, so this motivates the AP to ask the STA to report this time measurement. This is t0 for when the STA decides to authenticate to the AP.
5. Transmission of the first try of an authentication frame (which might be successful or not) as shown in FIG. 3. This often is not visible to the AP. Thus, this is useful for the AP to request the STA to report this time measurement. This is analogous to Tfirst, referred to above, for the first authentication frame.
6. Sidebar: If there is an out-of-band channel from the STA to the AP, then Tlast(0) (for authentication) is another useful milestone to report.
7. End of successful (i.e., acknowledged) exchange of first authentication frame. This is analogous to Tlast(1) referred to above for the first authentication frame. The times t3 and t4 are measurable at both the AP and the STA, so they can serve as a useful common reference.
8. Transmission of the first try of the last authentication frame (which might be successful or not). This is analogous to Tfirst referred to above for the last authentication frame. This is only relevant if the STA can make a measurement request of the AP.
9. End of successful (i.e., acknowledged) exchange of last authentication frame (this could be either AP to STA or STA to AP). This is analogous to Tlast(1) for the last authentication frame. Again, the times t3 and t4 are measurable at both the AP and the STA, so they can serve as a useful common reference.
10. STA decides to proceed with association. For example, this is t0 for association. This t0 minus the last milestone (successful authentication) is associated with software latency/delay on the STA.
11. Transmission of first try of association request frame (which might be successful or not). This is often not visible to the AP, hence the motivation for the AP to request the client to report this time measurement. This is analogous to Tfirst for association request.
12. Sidebar: If there is an out-of-band channel from the STA to the AP, then Tlast(0) for association is another useful milestone.
13. End of successful (i.e., acknowledged) exchange of association request frame. This is analogous to Tlast(1) for association request. The times t3 and t4 are measurable at both the AP and the STA, so they can serve as a useful common reference.
14. Transmission of the first try of an association response frame (which might be successful or not). This is analogous to Tfirst for an association response frame. This is only relevant if the STA can make a measurement request of the AP.
15. End of successful (i.e., acknowledged) exchange of an association response frame. This is analogous to Tlast(1) for the association response.
16. In each of the above authentication and association phases, there are 5 milestones per phase (milestones 4-9 for authentication, milestones 10-15 for association), although within that 5 milestones, one milestone is for STA-requested measurements only and one milestone is for the failure case, which is to be sent via some other means. Thus, there are at least three milestones per phase, referred to as “3-4-5” milestones per phase. Similarly, there are 3-4-5 milestones for each of post-association authentication, 4-way security protocol handshake, Dynamic Host Configuration Protocol (DHCP), any DHCP checks (e.g., checking that the assigned Internet Protocol (IP) address is indeed not assigned to another host), exiting any walled garden, and any Internet connectivity checks.

Due to privacy constraints, some STAs might not be willing (or configured) to report when they first wanted to discover an ESS, first discovered the associated AP's ESS, or first wanted to join an ESS. Therefore, it may be desirable to exclude or make optional or measure around the related components associated with these milestones.

DHCP, exiting any walled garden, and Internet connectivity checks are above (outside) the scope of IEEE 802.11. Therefore, in IEEE frames, it may be desirable to exclude or make optional related components from the reported subsets, i.e., define the onboarding process as ending before any of these events, before some of these events, or after all of these events, or splitting onboarding into pure-IEEE events and above-IEEE events, where the latter might be a field assigned to the Wi-Fi Alliance (WFA) for use.

The measurement request may be a single bit for a specific component subset(s) or a bitmap, with each bit position in the bitmap, when asserted, indicating a request for a specific component subset. There may be different requests for different components. As above, the request(s) might be carried in one or more of a Beacon, Probe Response, (Re)Association Response, Measurement Request frame, a vendor-specific management frame, or any other management frame as a field in an element, where the element might be an Ultra High Reliability (UHR) Operations element, a Seamless Mobility Domain (SMD) element, a Measurement Request element, a vendor-specific element, or any other element.

The measurement report may be one or more fields, one per component subset, in an element in a frame. The fields may be identified by the request via a Dialog Token, or identified by position, or a bitmap may be included to indicate which measurements are present, or each measurement may have a corresponding identification (e.g., subelement identifier (ID)). The fields may be carried in elements such as a Measurement Report element (of type "Statistics" or a new type such as "Upper Layer Onboarding Time", etc.), an SMD element, a (WFA)-defined vendor-specific element, or some other element. The elements may be carried in a frame such as a (Re)Association Request frame, another IEEE 802.11-defined management frame, or a WFA-defined vendor-specific management frame.

The following is a working example for an onboarding scenario.

Scanning time: A duration beginning at a maximum of (STA first discovering the ESS, wanting to join an ESS) and lasting until first successful (i.e., acknowledged) transmission of an authentication frame. This duration is presently unknown to the network. Since the AP knows the time of the first successful (i.e., acknowledged) transmission of an authentication frame, then the STA may only need to report a maximum of (STA first discovering the ESS, wanting to join an ESS), such as an absolute time using the Timing Synchronization Function (TSF) of its associated AP as the time base. Sending an absolute time simplifies implementation since there is no need to keep updating the frame as the STA waits for channel access and/or is retried. The Association Request frame is a natural container for this, such as, for example, in a new unsolicited or weakly solicited Measurement Report element of Measurement Type = Scanning-until-Auth-Start. "Unsolicited" may refer to the AP having Ultra High Reliability (UHR) capability. "Weakly solicited" may be an onboarding measurement request field in an element such as an UHR element or SMD element or a WFA field in a WFA element in a broadcast/unicast management frame such as a Beacon/Probe Response or a WFA vendor-specific management frame.

There is no need for reporting of authentication, association, Robust Security Network Association (RSNA)-related items since the network is aware of these already.

The STA may also report the time from the last received RSNA frame from the successful RSNA until the STA's Internet checks are complete (and optionally whether the process succeeded or failed). This measurement might be unsolicited, weakly solicited, or explicitly solicited by the AP via a new Measurement Request frame of Measurement Type = "(Upper Layer) Onboarding Time", to which the STA responds with a Measurement Report frame of Measurement Type = "(Upper Layer) Onboarding Time".

### Reporting Roaming Time

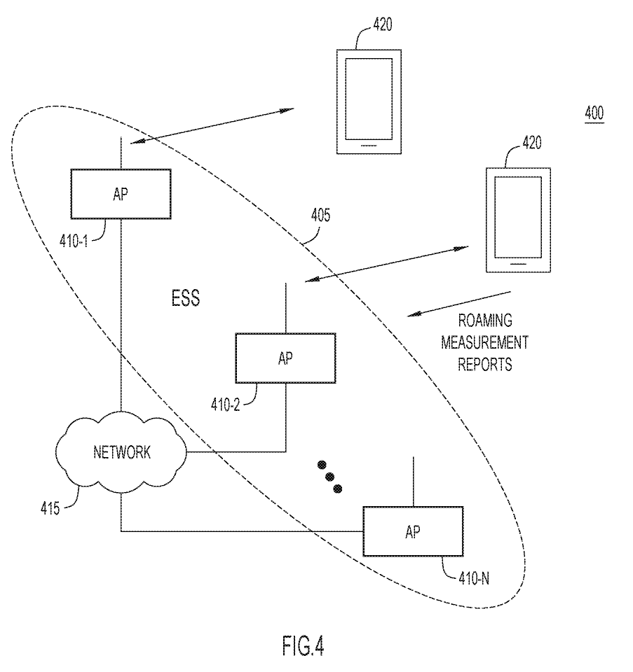

In accordance with another aspect, the ability is provided for a non-AP STA to report its roaming time to a target AP (i.e., STA after roaming completes). To this end, reference is made to FIG. 4. FIG. 4 shows a wireless network 400 that includes an ESS 405 comprising APs 410-1, 410-2, …, 410-N. The APs 410-1 to 410-N are connected to a network 415, such as a local area network or wide area network. A non-AP 420 (e.g., a wireless client or STA) is shown associated with AP 410-1 and then it roams from AP 410-1 to AP 410-2. The ESS 405 may be a seamless mobility domain (SMD). STAs associate with the entire SMD, not with just a single AP. This makes roaming smoother and faster. Again, one or more of the APs 410-1 to 410-N may be an AP MLD, and the non-AP 420 may be a Non-AP MLD.

Like the onboarding time, the roaming time can comprise multiple components (some of which the AP can determine autonomously and some of which it cannot). The time for one component or a concatenation of components can be signaled in many different but equivalent (e.g., convertible) ways, including (a) a duration, (b) a start and end time, (c) a start time when the peer can determine the end time, and (d) an end time when the peer can determine the start time.

Each of these signaling methods and the reporting of the time of individual components and concatenated components, one or more subsets of components, and all components, are heretofore not known. A component may be defined as the time between any two of the following milestones listed below. These milestones generally occur sequentially in the order that they are listed. The milestones associated with a frame exchange sequence described above in connection with FIG. 3 apply here to reporting on the timing associated with a STA roaming from one AP to another AP.

Thus, with the context described above in connection with FIG. 3, the roaming milestones may include the following, in sequential order as enumerated below.
1. STA first wants to discover a target AP (e.g., speculative scanning). The STA is always scanning to detect another AP, called the target AP, to which to roam if conditions to roam occur.
2. STA first discovers the target AP.
3. Each time that the STA goes off channel for scanning and/or returns. Thus, one possible component is the cumulative off-channel scanning time.
4. Each time that the STA awakens and/or sleeps for same-channel scanning. Thus, one possible component is the cumulative additional on-channel scanning time.
5. STA first wants to roam to the target AP. For example, this may be indicated by Receive Signal Strength Indicator (RSSI) information with the serving AP being appreciably worse than with the target AP.
6. Transmission of a first try of a first roaming-execution related frame with the serving AP (which might be successful or not). This often is not visible to the AP, and thus it is useful for the AP to request the STA to report this time measurement. This time measurement is analogous to Tfirst for an association request.
7. Sidebar: If there is an out-of-band channel from the STA to the AP (such as via the old AP), then Tlast(0) (for roaming) is another useful milestone.
8. End of successful (i.e., acknowledged) exchange of a first roaming-execution related frame with the serving AP. This is analogous to Tlast(1) for the first roaming-related frame with the serving AP. The times t3 and t4 are measurable at both the AP and the STA, so they can serve as a useful common reference.
9. End of successful (i.e., acknowledged) exchange of last non-roaming related frame with the serving AP. This is analogous to Tlast(1) for the last non-roaming-related frame with the serving AP. The times t3 and t4 are measurable at both the AP and the STA, so they can serve as a useful common reference.
10. Transmission of first try of last roaming-execution related frame with the serving AP (which might be successful or not). This is analogous to Tfirst for the last roaming-execution related frame. This is only relevant if the STA can make a measurement request of the AP.
11. End of successful (i.e., acknowledged) exchange of last roaming-execution related frame with the serving AP. This is analogous to Tlast(1) for the last roaming-execution related frame.
12. When the last non-roaming related uplink (UL) frame could have been transmitted to the serving AP based on the STA's general state (but not contention delays, absence of traffic, etc.).
13. When the last non-roaming related downlink (DL) frame could have been received from the serving AP based on the STA's general state (but not contention delays, absence of traffic, etc.).
14. When an UL frame could first have been transmitted to the target AP based on the STA's general state (but not contention delays, absence of traffic, etc.).
15. When a DL frame could first have been received from the target AP based on the STA's general state (but not contention delays, absence of traffic, etc.).
16. First frame was transmitted to the target AP (which might be successful or not). This distinction helps to reconcile the AP's perspective with the STA's perspective.
17. First frame was successfully transmitted (i.e., acknowledged) to the target AP.
18. As above, there can be four milestones per phase. The same four milestones can be used for each of authentication (if applicable), association (if applicable), RSNA (if applicable), DHCP, any DHCP checks, exiting any walled garden, and any Internet connectivity checks.

As for onboarding, due to privacy constraints, some STAs might not be capable or willing (or configured) to report parameters related to some/all of these roaming-related parameters. Therefore, it may be desirable to exclude or make optional or measure around the related components associated with these milestones.

As for onboarding, DHCP, exiting any walled garden, and Internet connectivity checks are above (outside) the scope of IEEE 802.11. Therefore, in IEEE frames, it may be desirable to exclude or make optional related components from the reported subsets. In other words, a roaming process may be defined as ending before any of these, before some of these, or after all of these. On the other hand, the Wi-Fi Alliance might instead or in addition define a protocol for milestones outside the scope of IEEE 802.11, so the protocol defined there would not be so constrained.

As described above in connection with onboarding, the roaming measurement reporting may involve reporting on when a first frame was transmitted to the target AP (which might be successful or not). This distinction may be useful to reconcile the AP's perspective with the client's perspective. Moreover, the roaming measurement reporting may involve reporting on when the first frame was successfully transmitted (i.e., acknowledged with the acknowledgement received by the transmitter) to the target AP.

Moreover, as described above for onboarding, there are 3-4-5 milestones per phase for roaming measurement reporting. For example, 3-4-5 milestones are defined for each of authentication (if applicable), association (if applicable), post-association authentication (if applicable), four-way security protocol handshake (if applicable), DHCP (if applicable), any DHCP checks (if applicable), exiting any walled garden, and any Internet connectivity checks (if applicable).

There are additional parameters that are signaled/reported. This may include the number of Media Access Control (MAC) Service Data Units (MSDUs / Aggregated MSDUs (A-MSDUs) / frames discarded due to expiry (staleness) while roaming, in total or per access category (AC), for all/selected ACs or per Traffic Identifier (TID), for all/selected TIDs. In addition, this may include the number of "holes" in the receive reorder buffer that are skipped over due to roaming, in total or per AC, for all/selected ACs or per TID for all/selected TIDs. Further, this may include the number of frames in the reorder buffer, after a hole, that are discarded due to roaming, in total or per AC, for all/selected ACs or per TID for all/selected TIDs.

The measurement request may contain a single bit or field indicating a request for a specific component subset(s) or a bitmap, with each bit position, when asserted, indicating a request for a specific component subset. More generally, the indication might come in a hierarchy of zero or more fields, subfields, elements, and subelements in any order and with duplication allowed (such as a field in a subelement in a field in an element). There might be different requests for different components. As above, the request(s) might be carried in one or more of a Beacon, Probe Response, (Re)Assoc Response, Measurement Request frame, Roaming Prep Response frame, a Roaming Execution Response frame, a vendor-specific management frame, or any other management frame as a field in an element where the element might be a UHR Operations element, an SMD element, a Measurement Request element, a vendor-specific element, or any other element.

The roaming measurement report may be one or more fields, one per component subset, in an element in a frame. The reported measurements might be identified by the request via a Dialog Token, or identified by position, or a bitmap might be included that indicates which measurements are present, or each measurement might have a corresponding identification (e.g., subelement ID). The reported measurement(s) might be carried in elements such as a Measurement Report element (of type "Statistics" or a new type such as "(Upper Layer) Roaming Time", etc.), an SMD element, a WFA-defined vendor-specific element, or some other element. More generally, the reported measurement(s) might come in a hierarchy of zero or more fields, subfields, elements, and subelements in any order and with duplication allowed (such as a field in a subelement in a field in an element). The hierarchy (e.g., top-level elements) might be carried in a frame such as a (Re)Assoc Req frame, a Measurement Report frame, a Roaming Prep/Execution Request frame (i.e., when the STA next wants to roam), another IEEE 802.11-defined management frame, or a WFA-defined vendor-specific management frame.

The following is an example of information related to components (determined from a plurality of ordered milestones) that may be reported for a roaming scenario.

Scanning time: beginning at when the STA wants to discover a target AP, and ending when the STA first successfully sends a roaming prep frame related to the target AP.

Scanning intensity: Amount of extra time spent on a channel for scanning and the amount of extra time spent off-channel for scanning.

UL data pause duration.

DL data pause duration.

(Optional) Time from the first successfully exchanged frame with the target AP until the STA's Internet checks are complete (and optionally, whether the process succeeded or failed).

Number of UL MSDUs per TID discarded due to roaming.

Number of DL frames per TID discarded due to roaming.

These metrics can help quantify the benefit of the roaming enhancements in UHR.

These reports apply equally to one or more of pre-Fast Transition (FT) roaming, FT, and SMD roaming. Related metrics for onboarding can help quantify the benefit of fast initial link setup (FILS), etc., and also highlight onboarding interoperability issues. Currently, wireless local networks have very little insight into onboarding delay.

### Frame Formats/Containers

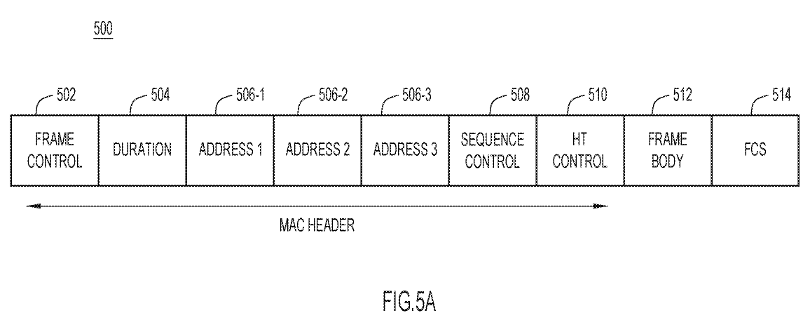

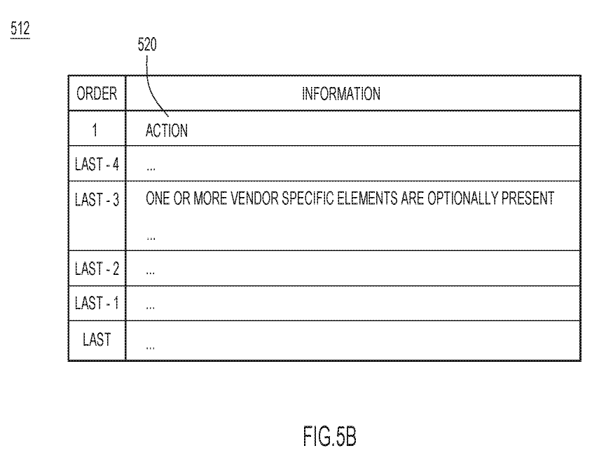

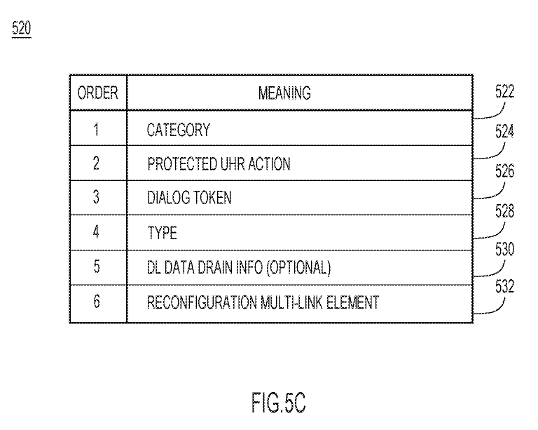

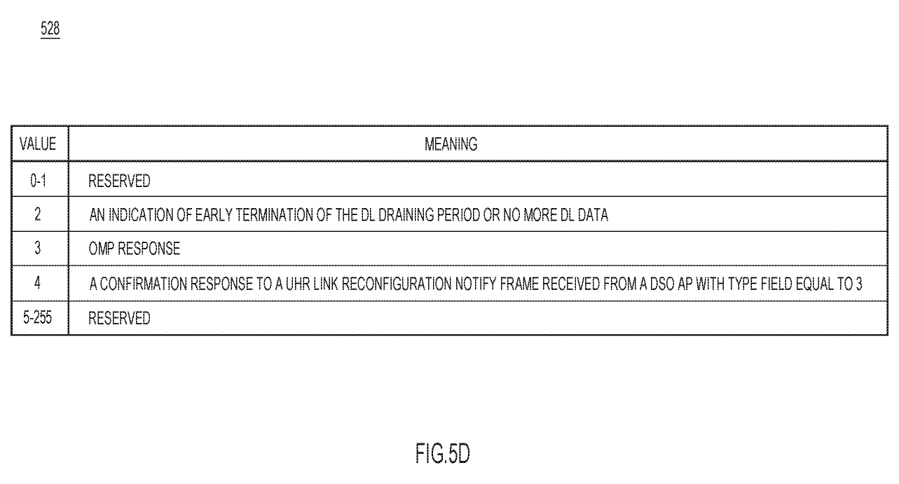

As described above, the measurement requests and measurement reports may be sent in a variety of frame formats and types. FIG. 5A illustrates an example in which a UHR Link Reconfiguration Notify frame (a type of management frame) 500 is used. The UHR Link Reconfiguration Notify frame 500 includes a frame control field 502, a frame control field 504, address fields 506-1, 506-2, and 506-3 for Address 1, Address 2, and Address 3, respectively, a sequence control field 508, a high-throughput (HT) control field 510, a frame body field 512 (of variable length), and a frame check sequence (FCS) field 514.

FIG. 5B illustrates an example of the frame body field 512 of an Action frame. The frame body field 512 includes an action field 520.

FIG. 5C illustrates a format of the action field 520. The action field 520 includes fields/elements for Category shown at 522, Protected UHR Action 524, Dialog Token 526, Type field 528, DL Data Drain Information (Info) 530, and Reconfiguration Multi-Link element 532.

FIG. 5D illustrates a new Type field, corresponding to the Type field 528 shown in FIG. 5C. The measurements for the various measurement reports referred to above may be contained in the Type field, such as an order value of 5 or another currently-reserved order value, such as 6 or 7. For value 4, a DSO AP refers to a Dynamic Sub-band Operation (DSO) AP.

After the Type field, a new element is included that could be a Measurement Report element or a new element to hold the measurement data, that may be reported in the action field 520 with order 7. For example, the Measurement Report element or new element may hold the onboarding measurement data. The new element may be formatted as one of the following and might include other fields not shown:
Element ID, Length, Element ID Extension (for onboarding), Onboarding Time
Element ID, Length, Element ID Extension (for onboarding), #measurements (optional), IDs of measurements (list of integers or a bitmap), List of Measurements
Element ID (for onboarding), Length, Element ID Extension (for onboarding), #tuples (optional), List of Measurement tuples (each comprising an ID followed by the measurement)

As another example, the Measurement Report element or new element may hold the roaming measurement data. The new element may be formatted as one of the following and might include other fields not shown:
Element ID, Length, Element ID Extension (for roaming), Roaming Time
Element ID, Length, Element ID Extension (for roaming), #measurements (optional), IDs of measurements (list of integers or a bitmap), List of Measurements
Element ID, Length, Element ID Extension (for roaming), #tuples (optional), List of Measurement tuples (each comprising an ID followed by the measurement)

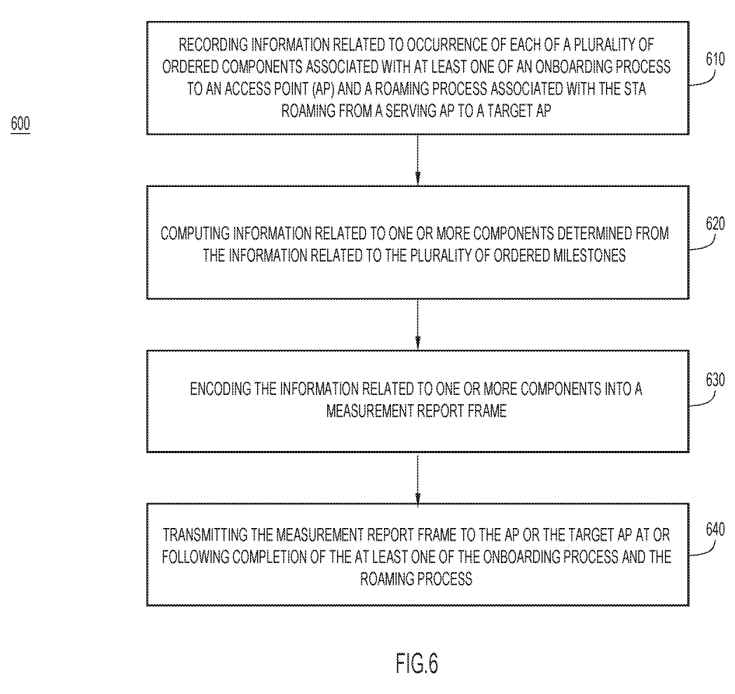

Turning now to FIG. 6, a flow chart is shown depicting a method 600 performed by a non-AP (STA) in a wireless network. The method 600 includes, at step 610, recording, by the STA, information related to the occurrence of each of a plurality of ordered milestones associated with at least one of an onboarding process to an access point (AP) and a roaming process associated with the STA roaming from a serving AP to a target AP. The plurality of ordered milestones comprise events spanning from a network discovery event to a network connectivity event.

At step 620, the method 600 involves the STA computing information related to one or more components determined from the information related to the plurality of ordered milestones.

At step 630, the method 600 includes encoding the information related to one or more components into a measurement report frame.

At step 640, the method 600 includes transmitting the measurement report frame (e.g., to the AP or the target AP) at or following completion or failure of at least one of the onboarding process and the roaming process.

In the method 600, the measurement report frame may include an identifier that identifies the one or more components.

In the method 600, recording the information related to occurrence of the plurality of ordered milestones during the onboarding process comprises recording local timestamps for at least one of the following:
a time at which the STA first discovers an extended service set (ESS);
a time at which the STA decides to join the ESS;
a time at which the STA selects the AP within the ESS;
a time of a first enqueuing for transmission of an authentication frame;
a time of a first successfully acknowledged authentication frame exchange;
a time of a first enqueuing for transmission of an association request frame;
a time of a first successfully acknowledged association request frame exchange; and
a time of a first successfully acknowledged association response frame exchange.

Similarly, in the method 600, recording the information related to occurrence of the plurality of ordered milestones during the onboarding process may further comprise recording timestamps for at least one of:
a time of completion of post-association authentication;
a time of completion of a four-way security handshake;
a time of completion of a Dynamic Host Configuration Protocol (DHCP) transaction;
a time of exit from a walled garden; and
a time of successful internet connectivity verification.

In the method 600, recording the information related to occurrence of the plurality of ordered milestones during the roaming process may involve recording local timestamps for:
a time at which the STA initiates scanning for the target AP; a time at which the STA discovers the target AP;
a time at which the STA decides to roam to the target AP;
a time of a first enqueuing for transmission of a first roaming-related frame to the serving AP;
a time of a first successfully acknowledged roaming-related frame exchange with the serving AP;
a time at which the STA could last have transmitted an uplink frame to the serving AP;
a time at which the STA could first transmit an uplink frame to the target AP;
a time of a first enqueuing for transmission of a frame to the target AP; and
a time of a first successfully completed frame exchange with the target AP.

In the method 600, computing the one or more components comprises computing at least one duration between a pair of milestones by computing at least one of:
an uplink data pause duration based on a duration between the time at which the STA could last have transmitted an uplink frame to the serving AP and the time at which the STA could first transmit an uplink frame to the target AP;
a downlink data pause duration based on a duration between a time of a last downlink frame received from the serving AP and a time of a first downlink frame received from the target AP;
a scanning duration based on a duration between the time at which the STA initiates scanning for the target AP and the time at which the STA discovers the target AP; and
a total roaming duration based on a duration between the time at which the STA decides to roam and the time of the first successfully acknowledged frame exchange with the target AP.

In the method 600, encoding the information may involve encoding at least one duration between a pair of components using at least one of:
a single duration value representing elapsed time between a selected pair of the plurality of ordered milestones;
a start timestamp and an end timestamp corresponding to the selected pair of the plurality of ordered milestones;
a start timestamp when the AP is configured to independently determine an end timestamp; and
an end timestamp when the AP is configured to independently determine a start timestamp.

The method 600 may further include: receiving, by the STA, a measurement request from the AP prior to transmitting the measurement report frame, wherein the measurement request specifies onboarding statistics associated with the onboarding process or the roaming process; and including the onboarding statistics or roaming statistics in the measurement report frame.

The method 600 may further include: parsing, by the STA, a beacon or probe response frame received from the AP to detect at least one bit or at least one field of the beacon or probe response frame, wherein the at least one bit or the at least one field indicates a request for at least one of an onboarding time report and a roaming time report; and autonomously generating and transmitting the measurement report frame upon completion of at least one of the onboarding process and the roaming process without receiving a per-event measurement request from the AP.

In the method 600, transmitting the measurement report frame may involve transmitting the measurement report frame as at least one of: a Measurement Report frame of a defined measurement type; a reassociation request frame comprising a Measurement Report element; an Ultra High Reliability (UHR) Link Reconfiguration Notify frame comprising a new type value designated for measurement reporting; and a vendor-specific management frame defined by a Wi-Fi Alliance Dynamic Analytics Reporting framework.

`In the method 600, encoding may further comprise encoding into the measurement report frame at least one supplementary parameter comprising at least one of:
a count of MAC Service Data Units (MSDUs) discarded due to staleness during the roaming process, reported in total or per access category or per Traffic Identifier;
a count of frames absent from a receive reorder buffer due to sequence number gaps during the roaming process, reported in total or per access category or per Traffic Identifier;
a count of frames in the receive reorder buffer discarded following a sequence number gap during the roaming process, reported in total or per access category or per Traffic Identifier; and
an indication of a time spent off-channel scanning for the target AP to which to roam.

In the method 600, recording, for at least one of the plurality of ordered milestones, comprises recording both:
a first transmission attempt timestamp corresponding to a time at which the STA first enqueues a frame for transmission, regardless of whether the frame is acknowledged by the AP; and
a first acknowledged transmission timestamp corresponding to a time at which the STA first successfully completes a frame exchange, a first successfully completed frame exchange being one in which an acknowledgment is received by the STA from the AP,
wherein at least one duration between at least one pair of components is encoded in the measurement report frame based on one or both of the first transmission attempt timestamp and the first acknowledged transmission timestamp.

In the method 600, for at least one of the plurality of ordered milestones, the first transmission attempt timestamp and the first acknowledged transmission timestamp differ due to one or more failed transmission attempts of the frame such that the at least one duration encoded in the measurement report frame reflects a total elapsed time across all transmission attempts, including failed attempts preceding the first successfully acknowledged frame exchange.

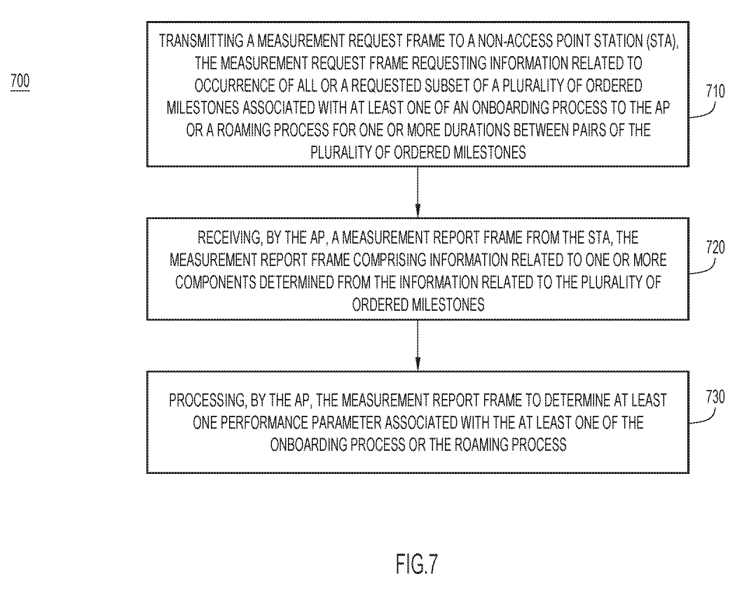

FIG. 7 illustrates a flow chart depicting a method 700 performed by an AP in a wireless network. The method 700 includes, at step 710, transmitting, by the AP, a measurement request frame to a non-access point station (STA), the measurement request frame requesting information related to the occurrence of all or a requested subset of a plurality of ordered milestones associated with at least one of an onboarding process to the AP or a roaming process for one or more durations between pairs of the plurality of ordered components.

At step 720, the method 700 includes receiving, by the AP, a measurement report frame from the STA, the measurement report frame comprising information related to one or more components determined from the information related to the plurality of ordered milestones.

At 730, the method 700 includes processing, by the AP, the measurement report frame to determine at least one performance parameter associated with the at least one of the onboarding process or the roaming process. The performance parameter could be a time duration between pairs of components or it could be the number of MSDUs/A-MSDUs/frames discarded due to expiry, as described above.

The method 700 may further include actions performed by the AP associated with the content of the measurement reports. For example, the AP may forward the one or more encoded duration values or timestamps from the measurement report frame to a network management platform (WLAN controller, etc.) for at least one of storage, statistical analysis, or protocol performance comparison. Moreover, the AP may determine, based on the at least one time measurement, a performance characteristic of the at least one of the onboarding process or the roaming process; and adjust at least one network configuration parameter based on the performance characteristic. The at least one network configuration parameter may comprise at least one of an enablement of Fast Transition, an enablement of Unsolicited Probe Response transmission, an enablement of Fast Initial Link Setup, or a roaming threshold value.

In the method 700, transmitting the measurement request frame may involve transmitting the measurement request frame as at least one of a Measurement Request frame defined under IEEE 802.11k, a Beacon frame comprising a bit set in an extended capabilities field indicating a request for at least one of an onboarding time report or a roaming time report, a Probe Response frame, a (Re)Association Response frame, or a vendor-specific management frame.

In the method 700, the measurement request frame may specify the requested subset of the plurality of ordered milestones using at least one of a bitmap with each asserted bit position corresponding to a defined milestone pair, an ordered list of milestone pair identifiers, or a single identifier requesting a total onboarding or roaming duration.

The method 700 may further include: forwarding, by the AP, the information related to one or more components from the measurement report frame to a network management platform for at least one of storage, statistical analysis, or protocol performance comparison.

The method 700 may further comprise: determining a performance characteristic of the at least one of the onboarding process or the roaming process; and adjusting, by the AP, at least one network configuration parameter based on the performance characteristic, the at least one network configuration parameter comprising at least one of an enablement of Fast Transition, an enablement of Unsolicited Probe Response transmission, an enablement of Fast Initial Link Setup, or a roaming threshold value.

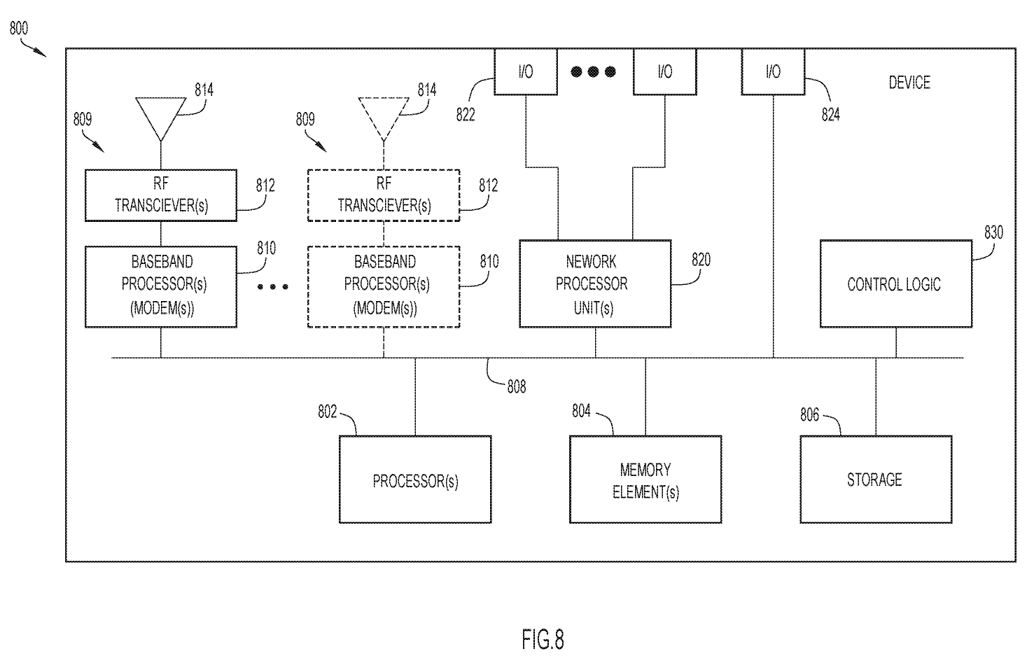

Referring to FIG. 8, FIG. 8 illustrates a hardware block diagram of an apparatus or device 800 that may perform functions associated with operations discussed herein in connection with the techniques described for embodiments herein. Device 800 may be inclusive of any AP and any STA as described for embodiments herein.

In at least one embodiment, the device 800 may be any apparatus that may include one or more processor(s) 802, one or more memory element(s) 804, storage 806, a bus 808, one or more radio modules (also called wireless transceivers) 809, each consisting of a baseband processor (modem) 810, one or more RF transceivers 812, and an antenna 814 (or group of antennas). The device 800 may further include one or more network processor unit(s) 820 interconnected with one or more network input/output (I/O) interface(s) 822, one or more I/O interface(s) 824, and control logic 830. In various embodiments, instructions associated with logic for device 800 can overlap in any manner and are not limited to the specific allocation of instructions and/or operations described herein.

In at least one embodiment, processor(s) 802 is/are at least one hardware processor configured to execute various tasks, operations, and/or functions for device 800 as described herein according to software and/or instructions configured for device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of the potential processing elements, microprocessors, digital signal processors, baseband signal processors, modems, PHY, controllers, systems, managers, logic, and/or machines described herein can be construed as being encompassed within the broad term 'processor'.

In at least one embodiment, memory element(s) 804 and/or storage 806 is/are configured to store data, information, software, and/or instructions associated with device 800, and/or logic configured for memory element(s) 804 and/or storage 806. For example, any logic described herein (e.g., control logic 830) can, in various embodiments, be stored for device 800 using any combination of memory element(s) 804 and/or storage 806. Note that in some embodiments, storage 806 can be consolidated with memory element(s) 804 (or vice versa) or can overlap/exist in any other suitable manner.

In at least one embodiment, bus 808 can be configured as an interface that enables one or more elements of device 800 to communicate in order to exchange information and/or data. Bus 808 can be implemented with any architecture designed for passing control, data, and/or information between processors, memory elements/storage, peripheral devices, and/or any other hardware and/or software components that may be configured for device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 820 may enable communication between device 800 and other systems, entities, etc., via network I/O interface(s) 822 (wired and/or wireless) to facilitate operations discussed for various embodiments described herein. In various embodiments, network processor unit(s) 820 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 800 and other systems, entities, etc. to facilitate operations for various embodiments described herein. In various embodiments, network I/O interface(s) 822 can be configured as one or more Ethernet port(s), Fibre Channel ports, any other I/O port(s), and/or antenna(s)/antenna array(s) now known or hereafter developed. Thus, the network processor unit(s) 820 and/or network I/O interface(s) 822 may include suitable interfaces for receiving, transmitting, and/or otherwise communicating data and/or information (wired and/or wirelessly) in a network environment.

I/O interface(s) 824 allow for input and output of data and/or information with other entities that may be connected to device 800. For example, I/O interface(s) 824 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 812 may perform RF transmission and RF reception of wireless signals via antenna(s) 814, and the baseband processor or modem 810 performs baseband modulation and demodulation, etc. associated with such signals to enable wireless communications for device 800.

In various embodiments, control logic 830 can include instructions that, when executed, cause processor(s) 802 to perform operations, which can include, but are not limited to, providing overall control operations of a computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that are capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with the teachings of the present disclosure.

In some instances, software of the present embodiments may be available via a non-transitory computer usable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form, an apparatus as shown and described herein is provided. In one form, a system as shown and described herein is provided. In one form, one or more computer readable storage media encoded with software comprising computer executable instructions is/are provided herein that, when the software is/are executed, is/are operable to perform operations as shown and described herein.

In some aspects, the techniques described herein relate to a method performed by a non-access point station (STA) in a wireless network, the method including: recording, by the STA, information related to occurrence of each of a plurality of ordered milestones associated with at least one of an onboarding process to an access point (AP) and a roaming process associated with the STA roaming from a serving AP to a target AP, wherein the plurality of ordered milestones include events spanning from a network discovery event to a network connectivity event; computing information related to one or more components determined from the information related to the plurality of ordered milestones; encoding the information related to the one or more components into a measurement report frame; and transmitting the measurement report frame to the AP or the target AP at or following completion of the at least one of the onboarding process and the roaming process.

In some aspects, the techniques described herein relate to a method performed by an access point (AP) in a wireless network, the method including: transmitting, by the AP, a measurement request frame to a non-access point station (STA), the measurement request frame requesting information related to occurrence of all or a requested subset of a plurality of ordered milestones associated with at least one of an onboarding process to the AP or a roaming process for one or more durations between pairs of the plurality of ordered milestones; receiving, by the AP, a measurement report frame from the STA, the measurement report frame including information related to one or more components determined from the information related to the plurality of ordered milestones; and processing, by the AP, the measurement report frame to determine at least one performance parameter associated with the at least one of the onboarding process or the roaming process.

In some aspects, the techniques described herein relate to a wireless station including: at least one wireless transceiver configured to transmit and receive signals in a wireless network; a memory; and a processor coupled to the at least one wireless transceiver and the memory, wherein the processor is configured to perform operations including: recording information related to occurrence of each of a plurality of ordered milestones associated with at least one of an onboarding process to an access point (AP) and a roaming process associated with the wireless station roaming from a serving AP to a target AP, wherein the plurality of ordered milestones include events spanning from a network discovery event to a network connectivity event; computing information related to one or more components determined from the information related to the plurality of ordered milestones; encoding the information related to the one or more components into a measurement report frame; and transmitting the measurement report frame to the AP or the target AP at or following completion of the at least one of the onboarding process and the roaming process.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used, such as electric, sound, light, infrared, and/or radio, to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc., which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of conventional or other databases, data stores, or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic, or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further, as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained by one skilled in the art and it is intended that the present disclosure encompass all such changes, substitutions, variations, alterations, and/or modifications as falling within the scope of the appended claims.

What is claimed is:

1. A method performed by a non-access point station (STA) in a wireless network, the method comprising:
recording, by the STA, information related to occurrence of each of a plurality of ordered milestones associated with at least one of an onboarding process to an access point (AP) and a roaming process associated with the STA roaming from a serving AP to a target AP, wherein the plurality of ordered milestones comprise events spanning from a network discovery event to a network connectivity event;
computing information related to one or more components determined from the information related to the plurality of ordered milestones;
encoding the information related to the one or more components into a measurement report frame; and
transmitting the measurement report frame to the AP or the target AP at or following completion of the at least one of the onboarding process and the roaming process.

2. The method of claim 1, wherein the measurement report frame includes an identifier that identifies the one or more components.

3. The method of claim 1, wherein recording the information related to occurrence of the plurality of ordered milestones during the onboarding process comprises recording local timestamps for at least one of the following:
a time at which the STA first discovers an extended service set (ESS);
a time at which the STA decides to join the ESS;
a time at which the STA selects the AP within the ESS;
a time of a first enqueuing for transmission of an authentication frame;
a time of a first successfully acknowledged authentication frame exchange;
a time of a first enqueuing for transmission of an association request frame;
a time of a first successfully acknowledged association request frame exchange; and
a time of a first successfully acknowledged association response frame exchange.

4. The method of claim 3, wherein recording the information related to occurrence of the plurality of ordered milestones during the onboarding process further comprises recording timestamps for at least one of:
a time of completion of post-association authentication;
a time of completion of a four-way security handshake;
a time of completion of a Dynamic Host Configuration Protocol (DHCP) transaction;
a time of exit from a walled garden; and
a time of successful internet connectivity verification.

5. The method of claim 1, wherein recording the information related to occurrence of the plurality of ordered milestones during the roaming process comprises recording local timestamps for:
a time at which the STA initiates scanning for the target AP;
a time at which the STA discovers the target AP;
a time at which the STA decides to roam to the target AP;
a time of a first enqueuing for transmission of a first roaming-related frame to the serving AP;
a time of a first successfully acknowledged roaming-related frame exchange with the serving AP;
a time at which the STA could last have transmitted an uplink frame to the serving AP;
a time at which the STA could first transmit an uplink frame to the target AP;
a time of a first enqueuing for transmission of a frame to the target AP; and
a time of a first successfully acknowledged frame exchange with the target AP.

6. The method of claim 5, wherein computing the one or more components comprises computing at least one duration between a pair of milestones by computing at least one of:
an uplink data pause duration based on a duration between the time at which the STA could last have transmitted an uplink frame to the serving AP and the time at which the STA could first transmit an uplink frame to the target AP;
a downlink data pause duration based on a duration between a time of a last downlink frame received from the serving AP and a time of a first downlink frame received from the target AP;
a scanning duration based on a duration between the time at which the STA initiates scanning for the target AP and the time at which the STA discovers the target AP; and
a total roaming duration based on a duration between the time at which the STA decides to roam and the time of the first successfully acknowledged frame exchange with the target AP.

7. The method of claim 1, wherein encoding the information comprises encoding at least one duration between a pair of milestones using at least one of:
a single duration value representing elapsed time between a selected pair of the plurality of ordered milestones;
a start timestamp and an end timestamp corresponding to the selected pair of the plurality of ordered milestones;
a start timestamp when the AP is configured to independently determine an end timestamp; and
an end timestamp when the AP is configured to independently determine a start timestamp.

8. The method of claim 1, further comprising:
receiving, by the STA, a measurement request from the AP prior to transmitting the measurement report frame, wherein the measurement request specifies onboarding statistics associated with the onboarding process or the roaming process; and
including the onboarding statistics or roaming statistics in the measurement report frame.

9. The method of claim 1, further comprising:
parsing, by the STA, a beacon or probe response frame received from the AP to detect at least one bit or at least one field of the beacon or probe response frame, wherein the at least one bit or the at least one field indicates a request for at least one of an onboarding time report and a roaming time report; and
autonomously generating and transmitting the measurement report frame upon completion of at least one of the onboarding process and the roaming process without receiving a per-event measurement request from the AP.

10. The method of claim 1, wherein transmitting the measurement report frame comprises transmitting the measurement report frame as at least one of:
a Measurement Report frame of a defined measurement type;
a reassociation request frame comprising a Measurement Report element;
an Ultra High Reliability (UHR) Link Reconfiguration Notify frame comprising a new type value designated for measurement reporting; and
a vendor-specific management frame defined by a Wi-Fi Alliance Dynamic Analytics Reporting framework.

11. The method of claim 1, wherein encoding further comprises encoding into the measurement report frame at least one supplementary parameter comprising at least one of:
a count of MAC Service Data Units (MSDUs) discarded due to staleness during the roaming process, reported in total or per access category or per Traffic Identifier;
a count of frames absent from a receive reorder buffer due to sequence number gaps during the roaming process, reported in total or per access category or per Traffic Identifier;
a count of frames in the receive reorder buffer discarded following a sequence number gap during the roaming process, reported in total or per access category or per Traffic Identifier; and
an indication of a time spent off channel scanning for the target AP to which to roam.

12. The method of claim 1, wherein, for at least one of the plurality of ordered milestones, recording comprises recording both:
a first transmission attempt timestamp corresponding to a time at which the STA first enqueues a frame for transmission, regardless of whether the frame is acknowledged by the AP; and
a first acknowledged transmission timestamp corresponding to a time at which the STA first successfully completes a frame exchange, a first successfully completed frame exchange being one in which an acknowledgment is received by the STA from the AP,
wherein at least one duration between at least one pair of components is encoded in the measurement report frame based on one or both of the first transmission attempt timestamp and the first acknowledged transmission timestamp.

13. The method of claim 12, wherein for at least one of the plurality of ordered milestones, the first transmission attempt timestamp and the first acknowledged transmission timestamp differ due to one or more failed transmission attempts of the frame such that the at least one duration encoded in the measurement report frame reflects a total elapsed time across all transmission attempts including failed attempts preceding the first successfully completed frame exchange.

14. A method performed by an access point (AP) in a wireless network, the method comprising:
transmitting, by the AP, a measurement request frame to a non-access point station (STA), the measurement request frame requesting information related to occurrence of all or a requested subset of a plurality of ordered milestones associated with at least one of an onboarding process to the AP or a roaming process for one or more durations between pairs of the plurality of ordered milestones;
receiving, by the AP, a measurement report frame from the STA, the measurement report frame comprising information related to one or more components determined from the information related to the plurality of ordered milestones; and
processing, by the AP, the measurement report frame to determine at least one performance parameter associated with the at least one of the onboarding process or the roaming process.

15. The method of claim 14, wherein transmitting the measurement request frame comprises transmitting the measurement request frame as at least one of a Measurement Request frame defined under IEEE 802.11k, a Beacon frame comprising a bit set in an extended capabilities field indicating a request for at least one of an onboarding time report or a roaming time report, a Probe Response frame, a (Re)Association Response frame, or a vendor-specific management frame.

16. The method of claim 14, wherein the measurement request frame specifies the requested subset of the plurality of ordered milestones using at least one of a bitmap with each asserted bit position corresponding to a defined milestone pair, an ordered list of milestone pair identifiers, or a single identifier requesting a total onboarding or roaming duration.

17. The method of claim 14, further comprising forwarding, by the AP, the information related to one or more components from the measurement report frame to a network management platform for at least one of storage, statistical analysis, or protocol performance comparison.

18. The method of claim 14, further comprising:
determining a performance characteristic of the at least one of the onboarding process or the roaming process; and
adjusting, by the AP, at least one network configuration parameter based on the performance characteristic, the at least one network configuration parameter comprising at least one of an enablement of Fast Transition, an enablement of Unsolicited Probe Response transmission, an enablement of Fast Initial Link Setup, or a roaming threshold value.

19. A wireless station comprising:
at least one wireless transceiver configured to transmit and receive signals in a wireless network;
a memory; and
a processor coupled to the at least one wireless transceiver and the memory, wherein the processor is configured to perform operations including:
recording information related to occurrence of each of a plurality of ordered milestones associated with at least one of an onboarding process to an access point (AP) and a roaming process associated with the wireless station roaming from a serving AP to a target AP, wherein the plurality of ordered milestones comprise events spanning from a network discovery event to a network connectivity event;
computing information related to one or more components determined from the information related to the plurality of ordered milestones;
encoding the information related to the one or more components into a measurement report frame; and
transmitting the measurement report frame to the AP or the target AP at or following completion of the at least one of the onboarding process and the roaming process.

20. The wireless station of claim 19, wherein the processor is further configured to compute at least one duration between a pair of milestones by computing at least one of:
an uplink data pause duration based on a duration between a time at which the wireless station could last have transmitted an uplink frame to the serving AP and a time at which the wireless station could first transmit an uplink frame to the target AP;
a downlink data pause duration based on a duration between a time of a last downlink frame received from the serving AP and a time of a first downlink frame received from the target AP;
a scanning duration based on a duration between the time at which the wireless station initiates scanning for the target AP and the time at which the wireless station discovers the target AP; and
a total roaming duration based on a duration between the time at which the wireless station decides to roam and the time of a first successfully acknowledged frame exchange with the target AP.

21. The wireless station of claim 19, wherein encoding information comprises encoding at least one duration between a pair of milestones using at least one of:
a single duration value representing elapsed time between a selected pair of the plurality of milestones;
a start timestamp and an end timestamp corresponding to the selected pair of the plurality of ordered milestones;
a start timestamp when the AP is configured to independently determine an end timestamp; and
an end timestamp when the AP is configured to independently determine a start timestamp.

22. The wireless station of claim 19, wherein the processor is further configured to perform operations including:
parsing a beacon or probe response frame received from the AP to detect at least one bit or at least one field of the beacon or probe response frame, wherein the at least one bit or the at least one field indicates a request for at least one of an onboarding time report and a roaming time report; and
autonomously generating for transmission by the at least one wireless transceiver the measurement report frame upon completion of at least one of the onboarding process and the roaming process without receiving a per-event measurement request from the AP.
